(19) United States
(12) Patent Application Publication
(10) Pub. No.: US 2023/0350736 A1
(43) Pub. Date: Nov. 2, 2023

(54) DISTRIBUTED FLOW CORRELATION

(71) Applicant: VMware, Inc., Palo Alto, CA (US)

(72) Inventors: Vishal Agarwal, Pune (IN); Suma Samsekai Manjabhat, Bangalore (IN)

(21) Appl. No.: 17/735,040

(22) Filed: May 2, 2022

(51) Int. Cl. G06F 9/54; G06F 11/34

(52) U.S. Cl. CPC G06F 9/542; G06F 11/3495

(57) ABSTRACT

Some embodiments of the invention provide a method for correlating data message flows sent between multiple machines executing on multiple host computers of a network. The method is performed at a first host computer executing a first machine. The method sends, to a second machine executing on a second host computer, a first data message belonging to a first data message flow between the first and second machines. The method receives a destination event associated with the first data message from the second host computer. The method correlates the received destination event with a source event associated with the first data message and generated by the first host computer to create a correlated event. The method sends the correlated event to a centralized data analytics appliance that analyzes and stores correlated events.

### BACKGROUND

Today, flow correlation is typically performed by a single appliance (e.g., VMware, Inc.'s NSX Intelligence). The correlation operations performed by such appliances tend to require a large amount of resources. Issues with asynchronous receipt of event data require extra processing time (i.e., extra CPU), as well as extra memory (RAM). These appliances allow for limited scale and have an increased chance of data loss when the incoming flow event rate is higher than what the appliance can support, which can lead to processing delays. Additionally, the appliances are a single point of failure in the event the appliance crashes or otherwise goes down.

### BRIEF SUMMARY

Some embodiments of the invention provide a method for correlating data message flows sent between machines executing on host computers of a network. The method of some embodiments is performed at a first host computer executing a first machine. The method sends, to a second machine executing on a second host computer, a first data message belonging to a first data message flow between the first and second machines. The method receives a destination event associated with the first data message from the second host computer, and correlates the received destination event with a source event associated with the first data message and generated by the first host computer to create a correlated event. The method then sends the correlated event to a centralized data analytics appliance that analyzes and stores correlated events.

In some embodiments, the first data message is sent to multiple machines executing on multiple host computers, including the second machine on the second host computer. In some such embodiments, the source host computer receives destination events from each of the host computers to which the first data message was sent, and correlates all of these destination events with the source event for sending to the centralized data analytics appliance. The first data message, in some such embodiments, is a multicast data message, while in other embodiments, the first data message is a broadcast first data message.

When a destination host computer (e.g., the second host computer) receives a data message, in some embodiments, it generates a destination event associated with the data message and sends the data message to the source host computer's queue. The destination event, in some embodiments, indicates whether the first data message was allowed at the destination host computer, or blocked at the destination host computer. In some embodiments, a data message sent by a source host computer to a destination host computer is blocked by the source host computer. Upon detecting that a data message was blocked, the source host computer generates a correlated event indicating that the data message flow between a source machine on the source host computer and a destination machine on the destination host computer was blocked by the source host computer, and sends the correlated event to the centralized data analytics appliance.

In some embodiments, while the data messages exchanged between machines and host computers are sent on the data plane, the events (i.e., destination events from the destination host computers to the source host computers, and the correlated events from the source host computers to the centralized data analytics appliance) are sent on the management plane. The first host computer (i.e., source host computer) in some embodiments, is configured to send correlated events to the centralized data analytics appliance at a specified frequency. The centralized data analytics appliance, in some embodiments, analyzes the correlated events to identify anomalous behavior (e.g., packet drops) and provide any identified anomalous behavior for display on a user interface (UI).

Each host computer includes a queue for receiving destination events from destination host computers, in some embodiments. Each queue, in some embodiments, is assigned an IP address that differs from the IP address of its corresponding host computer and to which the destination events are addressed. In addition to a queue, each host computer also includes a buffer for storing source events while the source host computer waits to receive one or more corresponding destination events. In some embodiments, the source host computer stores generated source events in the buffer for a fixed duration of time, and when the fixed duration of time has ended, source events for which destination events have not yet been received are either dropped or sent to the centralized data analytics appliance as incomplete.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 illustrates a work flow of some embodiments for correlating event data on host computers in a network and providing the correlated event data to a centralized data analytics appliance.

FIG. 2 conceptually illustrates a process performed by a source host computer in some embodiments of the invention.

FIG. 3 conceptually illustrates a process performed by a destination host computer in some embodiments.

FIG. 4 illustrates a work flow of some embodiments for correlating event data associated with multicast and broadcast messages in a network.

FIG. 5 conceptually illustrates a process performed by the centralized data analytics appliance of some embodiments to detect anomalous behavior as it receives correlated event data from source host computers.

FIG. 6 illustrates a host computer of some embodiments that uses context exporter and flow exporter to collect, correlate, aggregate, and publish aggregated and correlated data to an analysis appliance (e.g., a centralized data analytics appliance).

FIG. 7 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for correlating data message flows sent between machines executing on host computers of a network. The method of some embodiments is performed at a first host computer executing a first machine. The method sends, to a second machine executing on a second host computer, a first data message belonging to a first data message flow between the first and second machines. The method receives a destination event associated with the first data message from the second host computer, and correlates the received destination event with a source event associated with the first data message and generated by the first host computer to create a correlated event. The method then sends the correlated event to a centralized data analytics appliance that analyzes and stores correlated events.

In some embodiments, when a destination host computer (e.g., the second host computer) receives a data message it generates a destination event associated with the data message and sends the data message to the source host computer's queue. The destination event, in some embodiments, indicates whether the first data message was allowed at the destination host computer, or blocked at the destination host computer. In some embodiments, a data message sent by a source host computer to a destination host computer is blocked by the source host computer. Upon detecting that a data message was blocked, the source host computer generates a correlated event indicating that the data message flow between a source machine on the source host computer and a destination machine on the destination host computer was blocked by the source host computer, and sends the correlated event to the centralized data analytics appliance.

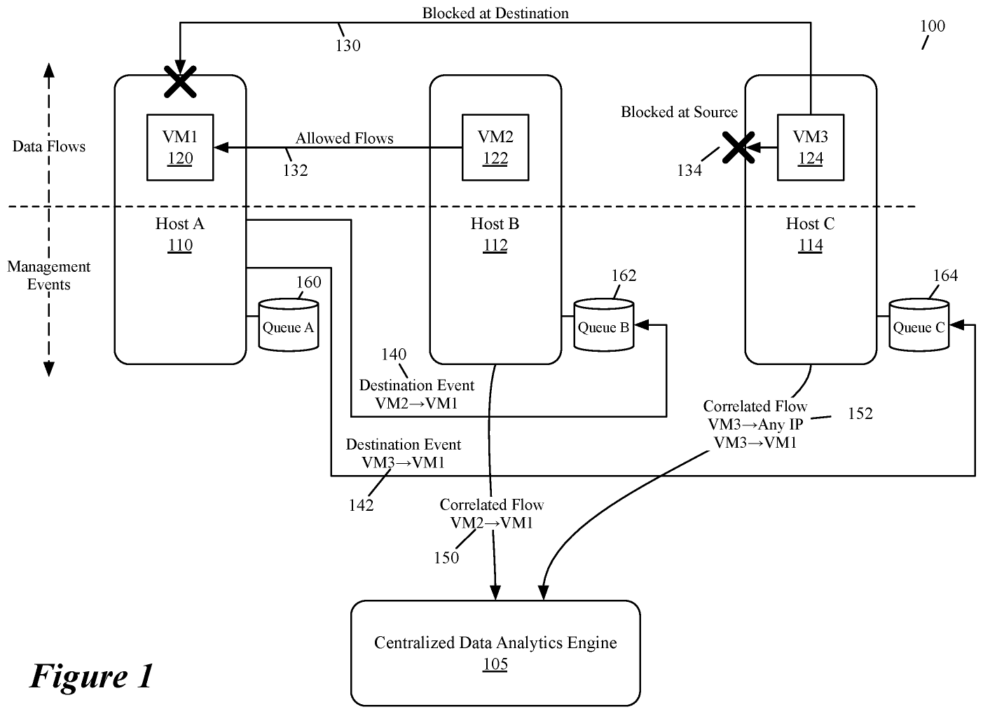

FIG. 1 illustrates a work flow of some embodiments for correlating event data on host computers in a network and providing the correlated event data to a centralized data analytics appliance. The network 100 includes a centralized data analytics appliance 105, a set of host computers 110, 112, and 114, each of which executes a respective virtual machine (VM) 120, 122, and 124. Additionally, each host computer includes a respective queue 160, 162, and 164, for receiving destination events from destination host computers.

Each queue, in some embodiments, is assigned an IP address that differs from the IP address of its corresponding host computer. When sending destination events to source host computers, the destination host computers send these destination events to the IP address associated with the queue and to which the destination events are addressed. In addition to a queue, each host computer also includes a buffer for storing source events while the source host computer waits to receive one or more corresponding destination events. In some embodiments, the source host computer stores generated source events in the buffer for a fixed duration of time, and when the fixed duration of time has ended, source events for which destination events have not yet been received are either dropped or sent to the centralized data analytics appliance as incomplete.

In some embodiments, while the data messages exchanged between machines and host computers are sent on the data plane, the events (i.e., destination events from the destination host computers to the source host computers, and the correlated events from the source host computers to the centralized data analytics appliance) are sent on the management plane. The management plane, in some embodiments, is implemented by several software forwarding elements (e.g., software switches) executing on several host computers, e.g., implemented as one logical switched by multiple software switches executing on multiple host computers. Similarly, the data plane is also implemented by several software forwarding elements executing on several host computers, in some embodiments. In some embodiments, the same software forwarding element implement both the management plane and data plane, while in other embodiments, the management plane and data plane are implemented by different software forwarding elements executing on the multiple host computers.

For instance, when the host computer 110 receives (on the data plane) and allows flows 132 from VM 122 on host computer 112 to VM 120 on host computer 110, the host computer 110 generates and sends on the management plane a destination event 140 to the queue 162 of host computer 112. The host computer 112 retrieves the destination event 140 from the queue 162, correlates this destination event with a generated source event retrieved from a buffer (not shown) of the host computer 112, and sends the correlated event data 150 to the centralized data analytics appliance 105 for analysis and storage. In some embodiments, the events are sent on the management plane using a communication protocol that is topic-based (e.g., Kafka™).

In addition to generating destination events associated with allowed flows, the host computers are also configured to generate and send destination events association with flows that are blocked at the destination host computer. For instance, the flows 130 from VM 124 on host computer 114 to VM 120 on host computer 110 are blocked at the host computer 110, as shown. The host computer 110 still generates a destination event 142 and sends this destination event 142 on the management plane to the queue 164 of the source host computer 114. The host computer 114 correlates this destination event 142 with a generated source event (not shown) retrieved from a buffer (not shown) of the host computer 114.

In some embodiments, for data messages blocked at the source host computer, such as the flow 134 from VM 124 that is blocked at the host computer 114, the source host computer generates a correlated event indicating that the data message flow between the VM 124 and any IP address was blocked by the source host computer. Each host computer in some embodiments, is configured to correlate generated source events with received destination events, and to send the correlated event data to the centralized data analytics appliance 105 at a specified frequency. The host computers 110-114, in some embodiments, do not continue to store the event data after sending the correlated event data to the centralized data analytics appliance 105. Accordingly, the host computer 114 sends correlated event data 152 for both the flows 130 blocked at the destination and the flows 134 blocked at the source, to the centralized data analytics appliance 105.

The correlated event data, in some embodiments, includes correlated context data relating to the flows from machines (e.g., from guest introspection (GI) agents executing on the machines to collect data), such as sets of attributes of a data message flow and machine. The sets of attributes, in some embodiments, can include any, or all, of data regarding (i) guest metadata, (ii) guest events, and (iii) guest DCN metrics. In some embodiments, the guest metadata includes any, or all, of data regarding a VM (e.g., a universally unique identifier [uuid], a bios uuid and a vmxpath), operating system data (e.g., type of OS and version information), and process data (e.g., process ID, creation time, hash, name, command line, security ID [sid], user ID [uid], loaded library or module information, process metrics [e.g., memory usage and CPU usage], process version, parent process ID, etc.). Guest events, in some embodiments, include VM events (e.g., power on and power off), user login events (e.g., login, logoff, connect, and disconnect events, a session ID, a timestamp, a VM IP, and a connected client IP), and service process events (e.g., event type [e.g., listen start, listen stop], timestamp, destination VM IP, destination port number, and process details). Guest VM metrics, in some embodiments, include memory usage and CPU usage. One of ordinary skill in the art will appreciate that much of the context data, in some embodiments, is not included in L2-L7 headers of a flow and that many additional pieces of information may be collected by a GI agent of a machine.

In some embodiments, each of the hosts 110-114 is responsible for collecting and reporting attributes of data flows along with the correlated event data. From the centralized data analytics appliance 105, the hosts 110-114 of some embodiments receive definitions of keys specifying attributes that define how flow data is to be aggregated. For example, a simple key that specifies a set of machine identifiers (e.g., a VM ID) as attribute values will, for each machine identifier, aggregate all flows with that machine identifier into a single aggregated flow group record. In some embodiments, the attributes specified in a key are any or all of: (1) attributes to generate key values for, (2) attributes to aggregate, and (3) attributes to ignore. In some embodiments, the keys also specify attribute values for which an entire set of flow data can be dropped and not aggregated (e.g., any flow that does not use one of a set of protocols [e.g., TCP, UDP, ESP, GRE, and SCTP], or is a broadcast or multicast flow is not processed). Other keys may specify ranges of values for which data is aggregated. Other keys, in some embodiments, specify attribute values that are not aggregated (e.g., source port).

The context data for each contextual attribute (e.g., source IP address, source port, destination IP address, destination port, protocol, SID, process hash, machine ID, version tag, service rules hit, CPU usage, memory usage, guest events, machine events, etc.) included in the sets of context data is concatenated in a corresponding field for the attribute, in some embodiments. In other embodiments, only unique attribute values are added to the aggregated contextual attributes, or some combination of the two methods for aggregating data is used in conjunction with other methods that are appropriate for different attributes. Contextual attribute sets, in different embodiments, are aggregated for any or all of each machine executing on the host (e.g., by machine identifier or IP address), each key value generated by a flow aggregator for flow group records (e.g., in embodiments that correlate flow group records to context data), or each of a set of flow tuples used to identify individual flows.

In some embodiments, while not shown, the centralized data analytics appliance 105 sends a confirmation to host computers indicating the event data has been received. In some embodiments, the confirmation includes a hash value or other value serving the function of a checksum to ensure that the data was transmitted and received intact. The confirmation is necessary, in some embodiments, because the correlated event data is not persisted on the host computer and a failed transmission could lead to a complete loss of the data. In some embodiments, the host computers each include a backup system for storing correlated event data in case of a disruption in the communication with the centralized data analytics appliance (e.g., during a centralized data analytics appliance upgrade).

The centralized data analytics appliance 105, in some embodiments, analyzes the correlated events to identify anomalous behavior (e.g., packet drops) and provide any identified anomalous behavior for display on a user interface (UI). In some embodiments, the centralized data analytics appliance 105, in some embodiments, is a server or cluster of servers that, based on the received data from each host computer, including the correlated event data, and configuration data from a network manager computer, processes the data to be stored in a time series data storage, and performs analysis on the stored data. In some embodiments, the centralized data analytics appliance (also referred to herein as an analysis appliance) also provides access to the stored data to additional elements of the system for visualization and alternative analysis. The centralized data analytics appliance, in some embodiments, provides a set of interfaces for receiving data from the host computers and the network manager and for interacting with a user through a user interface, a processing pipeline for flow data (e.g., flow group records received from host computers), a set of data storages for storing received data, and a set of data analysis engines (e.g., any or all of a visualization engine, anomaly detection engine, recommendation generation engine, and machine-trained engine (network), etc.).

Because the correlation is performed by the host computers, resources of the centralized analytics engine 105 can be used for other analytic operations other than flow correlation, according to some embodiments. Also, in some embodiments, users (e.g., network administrators) can specify what information the host computers 110-114 share with the centralized analytics engine 105. Additionally, the centralized analytics engine 105 is able to support a larger scale (e.g., 1 million flows in a datacenter), without risking a single point of failure.

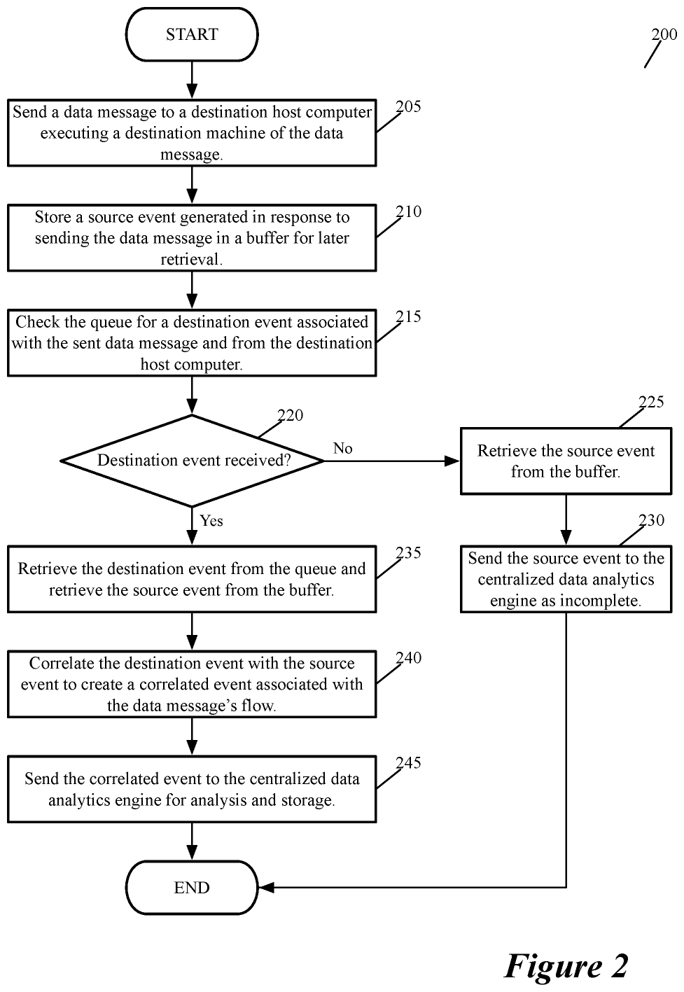

FIG. 2 conceptually illustrates a process performed by a source host computer in some embodiments of the invention. The process 200 will be described with reference to the work flow in the network 100 discussed above. The process 200 starts when the source host computer sends (at 205) a data message to a destination host computer executing a destination machine of the data message. For instance, the host computer 112 sends data messages belonging to data message flows 132 between the VM 122 on the host computer 112 and the VM 120 on the host computer 110.

The process stores (at 210) a source event generated in response to sending the data message in a buffer for later retrieval. As described above, each host computer includes a buffer for storing source events for a fixed duration of time. In some embodiments, the buffer is a FIFO (first-in first-out) storage that only stores a certain number of source events before old sets are overwritten (i.e., a circular or ring buffer).

The process checks (at 215) the queue for a destination event associated with the sent data message and from the destination host computer. For instance, the host computer 112 can check its queue 162 for a destination event associated with the allowed flows 132 from the host computer 110. In some embodiments, the buffer on the source host computer is a FIFO storage, and the source host computer checks the queue when the corresponding source event is next in the buffer. The queues, in some embodiments, are Kafka topics on which the destination events are written as a log of events, with each new destination event being written on the end of the log. In some embodiments, once a host computer retrieves a destination event from the queue, the retrieved destination event is no longer stored by the queue. Also, in some embodiments, destination events written to a host computer's queue expire after a particular duration of time (e.g., minutes, hours, days, etc.), while in other embodiments, the destination events are stored indefinitely.

The process determines (at 220) whether the destination event has been received. That is, the source host computer determines whether the destination event has been written to the queue. When the destination event has not been received, the process transitions to retrieve (at 225) the source event from the buffer, and sends (at 230) the source event to the centralized data analytics appliance as incomplete (e.g., as an incomplete flag set). In other embodiments, source events for which a destination event has not been received are dropped. Following 230 the process 200 ends.

When the destination event has been received, the process transitions to retrieve (at 235) the destination event from the queue and retrieve the source event from the buffer, and correlates (at 240) the destination event with the source event to create a correlated event associated with the data message and its flow. The correlated event, in some embodiments, is a collection of context data associated with the data message flow, such as source IP address, source port, destination IP address, destination port, protocol, SID, process hash, machine ID, version tag, service rules hit, CPU usage, memory usage, guest events, machine events, etc.

The process sends (at 245) the correlated event to the centralized data analytics appliance for analysis and storage. The host computer 112 sends correlated event data 150 on the management plane to the centralized data analytics appliance 105, for example. In some embodiments, the source host computer also receives confirmation from the centralized data analytics appliance indicating receipt of the correlated event data. In some such embodiments, the source host computer maintains the sent data until receipt of the confirmation to prevent potential data loss. Following 245, the process 200 ends.

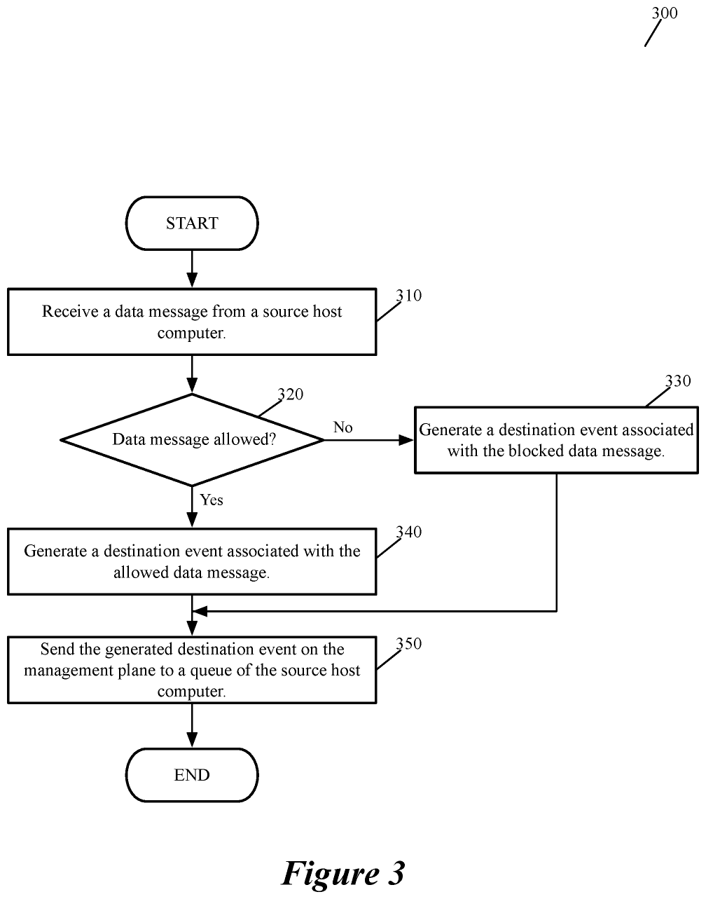

FIG. 3 conceptually illustrates a process performed by a destination host computer in some embodiments. Like the process 200, the process 300 will also be described with reference to FIG. 1. The process 300 starts when the destination host computer receives (at 310) a data message from a source host computer. The host computer 110, for example, is illustrated as receiving flows 130 and 132 for VM 120 from VMs 122 on host computer 112 and VM 124 on host computer 114, respectively.

The process determines (at 320) whether the data message is allowed. The host computers of some embodiments are configured to generate destination events for all data messages they receive, regardless of whether the data message is allowed or blocked at the host computer. When the data message is not allowed (i.e., is a blocked data message), the process transitions to generate (at 330) a destination event associated with the blocked data message. The process then transitions to send (at 350) the generated destination event on the management plane to a queue of the source host computer. The host computer 110, for instance, generates a destination event 142 for the blocked flow from VM 124 to VM 120, and sends this destination event 142 on the management plane to the queue 164 of host computer 114 (i.e., the source host computer for the blocked flow 130). In some embodiments, the destination event 142 indicates anomalous behavior based on the flow 130 being blocked. Following 350, the process 300 ends.

When the data message is allowed, the process transitions to generate (at 340) a destination event associated with the allowed data message. In addition to the destination event 142 associated with the blocked flow 130, the host computer 110 also generates a destination event 140 associated with the allow flows 132 between the VM 122 and the VM 120. The process then sends (at 350) the generated destination event on the management plane to the queue of the source host computer. Following 350, the process 300 ends.

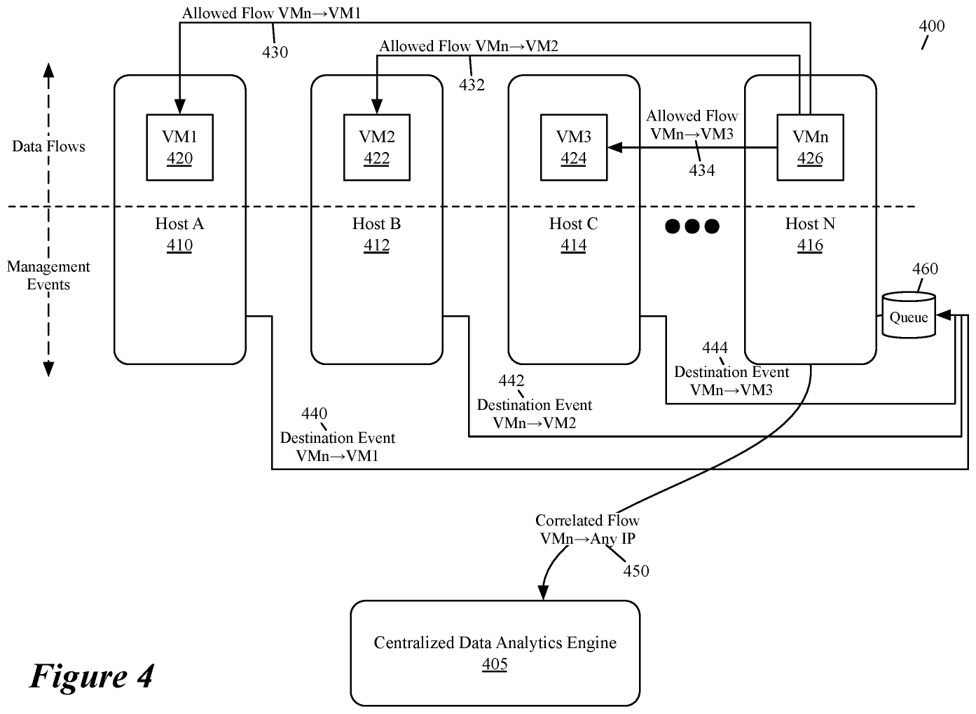

In some embodiments, a source host computer sends a data message to multiple machines executing on multiple different host computers, such as a multicast data message or a broadcast data message. In some such embodiments, the source host computer receives destination events from each of the destination host computers to which the first data message was sent, and correlates all of these destination events with the source event for sending to the centralized data analytics appliance. FIG. 4 illustrates a work flow of some embodiments for correlating event data associated with multicast and broadcast messages in a network.

The network 400 includes host computers 410, 412, 414, and 416, as well as a centralized data analytics appliance 405. Each of the host computers 410-416 executes a respective VM 420, 422, 424, and 426. While only the host computer 416 is illustrated with a corresponding queue 460, it should be understood that each host computer illustrated also has their own respective queue (not shown) for receiving destination events when operating as source host computers.

The host computer 416 sends data messages belonging to allowed flows 430, 432, and 434 from the VM 426 to each of the VMs 420, 422, and 424. In some embodiments, these data message flows are multicast data message flows, while in other embodiments, these data message flows are broadcast data message flows. Upon receipt of the multicast or broadcast data message, each destination host computer 410, 412, and 414 sends a destination event 440, 442, and 444 to the source computer's queue 460, as shown. Because the host computer 416 is the source host computer for these flows, it knows how many destination events to expect for correlation with the single source event associated with the flows.

In some embodiments, each host computer is configured to store generated source events in the buffer for a fixed duration of time, and when the fixed duration of time has ended, source events for which destination events have not yet been received are either dropped or sent to the centralized data analytics appliance as incomplete. When the source event is associated with a multicast or broadcast data message, some embodiments correlate the received destination events with the source event and indicate (e.g., with a flag) which, if any, intended destinations of the data message did not return a destination event.

After the fixed duration of time, the host computer 416 retrieves the received destination events from the queue 460, and correlates all of these received destination events with the corresponding source event from the buffer (not shown). The host computer 416 then sends the correlated event data 450 to the centralized data analytics appliance 405 on the management plane for analysis and storage.

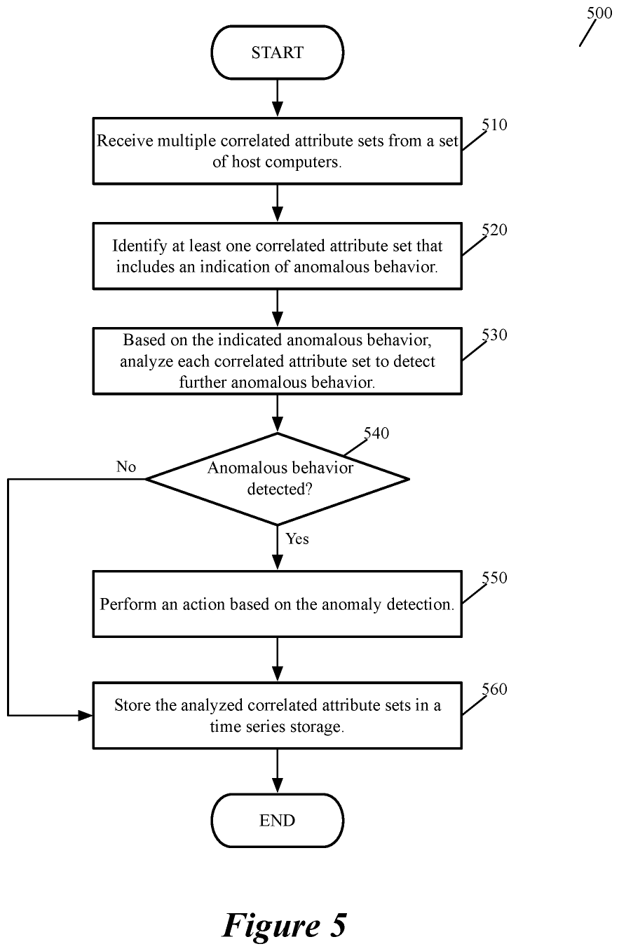

As mentioned above, the centralized data analytics appliance of some embodiments analyzes correlated event data to identify anomalous behavior (e.g., packet drops) and provide any identified anomalous behavior for display on a user interface (UI). FIG. 5 conceptually illustrates a process performed by the centralized data analytics appliance of some embodiments to detect anomalous behavior as it receives correlated event data from source host computers. The process 500, in some embodiments, represents an anomaly detection process for a single set of data related to a single flow and is performed for additional sets of data for additional flows as they are stored by the centralized data analytics appliance. The process 500 starts when the centralized data analytics appliance receives (at 510) multiple correlated attribute sets (i.e., multiple correlated events) from a set of host computers. In some embodiments, the centralized data analytics appliance stores the received correlated event data as it receives the data, and later retrieves the data from storage when it is ready to analyze the data.

The process identifies (at 520) at least one correlated attribute set that includes an indication of anomalous behavior. For instance, a correlated attribute set associated with a multicast data message flow may include one or more flags indicating that the source host computer corresponding to the flow did not receive destination events from one or more destination host computers to which data messages of the flow were sent. In another example, a correlated attribute set may indicate that a flow was blocked at the source or destination host computer.

Based on the indicated anomalous behavior, the process analyzes (at 530) each of the received correlated attribute sets to detect further anomalous behavior. In some embodiments, the analysis is stateful and considers past behavior (e.g., contextual attributes or collected statistics for previous flows). Such stateful analysis includes, in some embodiments, maintaining a mean value and standard deviation for certain statistics associated with flows that can be compared to current values of the statistics to determine if the current value represents anomalous behavior for the flow. The analysis, in some embodiments, additionally, or alternatively, includes stateless anomaly detection that looks at the flow and context data without considering past behavior of the specific flows. For example, the analysis may discover that a certain flow is using a certain port but that the context data associated with the flow indicates that the process using the port does not match to an expected process (or that the port does not match the process). One of ordinary skill in the art will appreciate that many other examples of stateful and stateless anomaly detection could be presented based on the types of data collected.

The process determines (at 540) whether anomalous behavior is detected. When anomalous behavior is detected, the process transitions perform (at 550) an action based on the detected anomaly. In some embodiments, the action is storing an indication of the anomalous behavior for presentation to a user (e.g., through a UI). In other embodiments, certain types of anomalies trigger specific remedial action (e.g., generating service rules to block flows related to the anomalous behavior until reviewed by an administrator) in addition to presenting an indication of the detected anomalous behavior.

After performing the action (at 550), or when no anomalous behavior is detected (at 540), the process stores (at 560) the analyzed correlated attribute sets in a time series storage. Following 560, the process 500 ends. In some embodiments, the process 500 is periodically or continually performed as a background process, while in other embodiments the process 500 is performed upon a user request made through a UI of the centralized data analytics appliance.

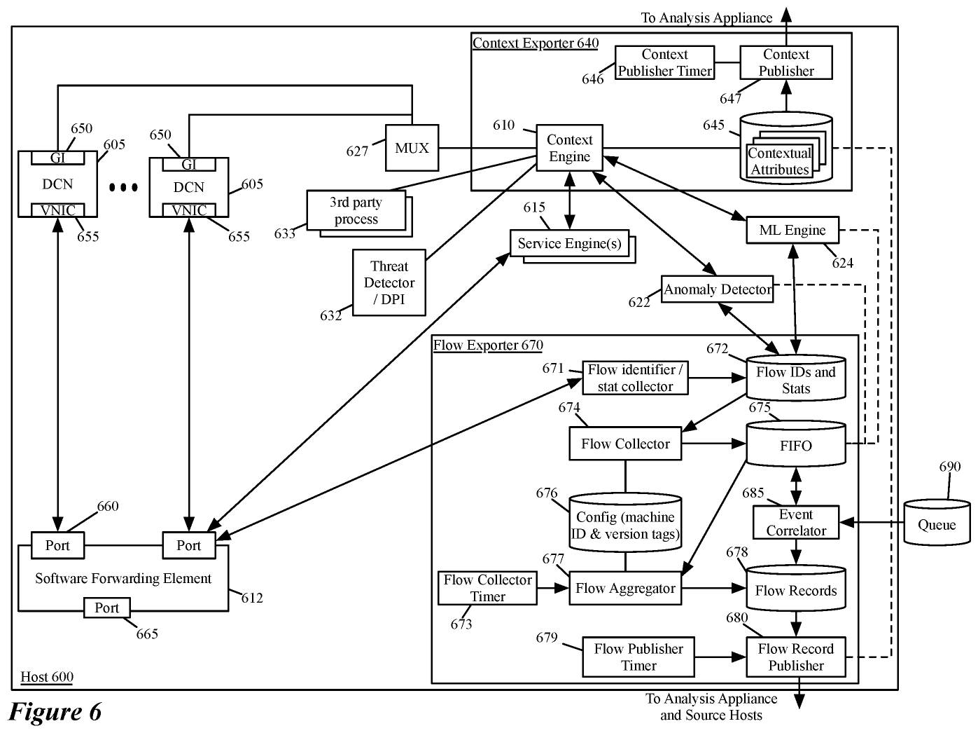

FIG. 6 illustrates part of a distributed analytical data collection system that includes a host computer 600 that uses context exporter 640 and flow exporter 670 to collect, correlate, aggregate, and publish aggregated and correlated data to an analysis appliance (e.g., a centralized data analytics appliance). In some embodiments, the host computer 600 is one of multiple host computers that use context exporters and flow exporters to collect, correlate, aggregate, and publish aggregated and correlated data to the analysis appliance as part of the distributed analytical data collection system. As shown, the host computer 600 includes: several data compute nodes (DCNs) 605, a set of guest introspection (GI) agents 650, a set of service engines 615, a threat detector/deep packet inspection (DPI) module 632, a set of third-party processes 633, a MUX (multiplexer) 627, and a context exporter 640 (including a context engine 610, a contextual attribute storage 645, a context publisher timer 646, and a context publisher 647) for processing context data (e.g., contextual attribute data sets) at host computer 600 and publishing the context data to an analysis appliance. Flow exporter 670, in some embodiments, includes flow identifier/statistics collector 671, flow identifier and statistics storage 672, flow collector timer 673, flow collector 674, first-in first-out (FIFO) storage 675, configuration data storage 676, flow aggregator 677, flow group record storage 678, flow publisher timer 679, event correlator 685 for correlating source events stored in the FIFO storage 675 with destination events written to the queue 690 of the host computer 600, and flow group record publisher 680 for collecting and processing flow data and publishing the processed flow data as a set of flow group records to an analysis appliance. Host computer 600, in some embodiments, also includes anomaly detector 622 and machine learning (ML) engine 624 that performs preliminary analysis based on the context data and flow data received from the flow exporter 670 (e.g., the flow identifiers and statistics stored in storage 672).

The guest introspection agents 650 execute on the DCNs 605 and extract context data from the DCNs 605. For example, a guest introspection agent 650, in some embodiments, detects that a new data flow has been initiated (e.g., by sending a SYN packet in a data flow using TCP) and collects introspection data (e.g., a set of attributes of the data flow and DCN). The introspection data, in some embodiments, includes any, or all, of data regarding (i) guest metadata, (ii) guest events, and (iii) guest DCN metrics. In some embodiments, the guest metadata includes any, or all, of data regarding DCN 605 (a universally unique identifier [uuid], a bios uuid and a vmxpath), operating system data (type of OS and version information), and process data (e.g., process ID, creation time, hash, name, command line, security ID [sid], user ID [uid], loaded library or module information, process metrics [e.g., memory usage and CPU usage], process version, parent process ID, etc.). Guest events, in some embodiments, include DCN 605 events (e.g., power on and power off), user login events (e.g., login, logoff, connect, and disconnect events, a session ID, a timestamp, a DCN IP, and a connected client IP), and service process events (e.g., event type [e.g., listen start, listen stop], timestamp, destination DCN IP, destination port number, and process details). Guest DCN metrics, in some embodiments, include memory usage and CPU usage. One of ordinary skill in the art will appreciate that much of the context data, in some embodiments, is not included in L2-L7 headers of a flow and that many additional pieces of information may be collected by guest introspection agent 650. The partial list above serves only as an example of the types of information that can be gathered by guest introspection agent 650.

The collected context information is sent, in some embodiments, to context engine 610 through MUX 627 to be provided to other elements of the host and for correlation with context data received from other sources. In some embodiments, the other sources include a set of service engines 615, threat detector/DPI module 632, third-party software (processes) 633, anomaly detector 622, and ML engine 624. Context engine 610, in some embodiments, correlates the context data from the multiple sources for providing the correlated context data (e.g., sets of correlated contextual attributes) to the context publisher 647 (e.g., through context attribute storage 645).

As shown, each DCN 605 also includes a virtual network interface card (VNIC) 655 in some embodiments. Each VNIC is responsible for exchanging messages between its DCN and the software forwarding element (SFE) 612. Each VNIC connects to a particular port 660-665 of the SFE 612. The SFE 612 also connects to a physical network interface card (PNIC) (not shown) of the host. In some embodiments, the VNICs are software abstractions created by the hypervisor of one or more physical NICs (PNICs) of the host.

In some embodiments, the SFE 612 maintains a single port 660-665 for each VNIC of each DCN. The SFE 612 connects to the host PNIC (through a NIC driver [not shown]) to send outgoing messages and to receive incoming messages. In some embodiments, the SFE 612 is defined to include a port 660-665 that connects to the PNIC's driver to send and receive messages to and from the PNIC. The SFE 612 performs message-processing operations to forward messages that it receives on one of its ports to another one of its ports. For example, in some embodiments, the SFE 612 tries to use data in the message (e.g., data in the message header) to match a message to flow-based rules, and upon finding a match, to perform the action specified by the matching rule (e.g., to hand the message to one of its ports 660-665, which directs the message to be supplied to a destination DCN or to the PNIC).

In some embodiments, the SFE 612 is a software switch, while in other embodiments it is a software router or a combined software switch/router. The SFE 612, in some embodiments, implements one or more logical forwarding elements (e.g., logical switches or logical routers) with SFEs 612 executing on other hosts in a multi-host environment. A logical forwarding element, in some embodiments, can span multiple hosts to connect DCNs that execute on different hosts but belong to one logical network.

Different logical forwarding elements can be defined to specify different logical networks for different users, and each logical forwarding element can be defined by multiple software forwarding elements on multiple hosts. Each logical forwarding element isolates the traffic of the DCNs of one logical network from the DCNs of another logical network that is serviced by another logical forwarding element. A logical forwarding element can connect DCNs executing on the same host and/or different hosts, both within a datacenter and across datacenters. In some embodiments, the SFE 612 extracts from a data message a logical network identifier (e.g., a VNI) and a MAC address. The SFE 612 in these embodiments uses the extracted VNI to identify a logical port group, and then uses the MAC address to identify a port within the port group.

Software switches (e.g., software switches of hypervisors) are sometimes referred to as virtual switches because they operate in software and they provide the DCNs with shared access to the PNIC(s) of the host. However, in this document, software switches are referred to as physical switches because they are items in the physical world. This terminology also differentiates software switches from logical switches, which are abstractions of the types of connections that are provided by the software switches. There are various mechanisms for creating logical switches from software switches. VXLAN provides one manner for creating such logical switches. The VXLAN standard is described in Mahalingam, Mallik; Dutt, Dinesh G.; et al. (2013-05-08), VXLAN: A Framework for Overlaying Virtualized Layer 2 Networks over Layer 3 Networks, IETF.

The ports of the SFE 612, in some embodiments, include one or more function calls to one or more modules that implement special input/output (I/O) operations on incoming and outgoing messages that are received at the ports 660-665. Examples of I/O operations that are implemented by the ports 660-665 include ARP broadcast suppression operations and DHCP broadcast suppression operations, as described in U.S. Pat. No. 9,548,965. Other I/O operations (such as firewall operations, load-balancing operations, network address translation operations, etc.) can be so implemented in some embodiments of the invention. By implementing a stack of such function calls, the ports 660-665 can implement a chain of I/O operations on incoming and/or outgoing messages in some embodiments.

Also, in some embodiments, other modules in the data path (such as the VNICs 655 and the ports 660-665, etc.) implement the I/O function call operations instead of, or in conjunction with, the ports 660. In some embodiments, one or more of function calls of the SFE ports 660-665 can be to service engines 615 that query context engine 610 for context information that service engines 615 use, in some embodiments, to generate context headers (e.g., headers including context data) that include context used in providing a service at the service engines 615 and, in some embodiments, identify service rules applied to provide the service. In some embodiments, the generated context headers are then provided through the port 660-665 of SFE 612 to flow exporter 670 (e.g., flow identifier and statistics collector 671). These generated context headers, in some embodiments, include destination events regarding data messages received by the host 600 from a source host, and are provided to the flow exporter 670 for delivery to the queues of the source hosts.

In some embodiments, as described above, the data messages exchanged between host computers are sent on the data plane, while the events are sent on the management plane. The management plane, in some embodiments, is implemented by several SFEs executing on several host computers, including the SFE 612 on the host computer 600. For instance, in some embodiments the management plane is implemented as one logical switch by multiple software switches executing on multiple host computers. In some embodiments, the data plane is implemented by the same SFEs as the management plane, while in other embodiments, the data plane is implemented by different SFEs on the multiple host computers. That is, in some embodiments, the SFE 612 implements the data plane along with other SFEs executing on other hosts (not shown), while a different SFE (not shown) executing on the host 600 implements the management plane along with still other SFEs executing on other hosts.

The data messages exchanged between machines on the data plane contain data datagrams from the source machine for consumption by the destination machine, according to some embodiments. Conversely, the destination events sent from the destination machines to the source machines do not contain datagrams for consumption by the source machines or by the destination machines. Instead, the events only contain metadata regarding the processing of the data message on destination machine.

Flow exporter 670 monitors flows, collects flow data and statistics, aggregates flow data into flow group records, and publishes flow group records for consumption by the analysis appliance. In some embodiments, flow exporter 670 generally aggregates statistics for individual flows identified during multiple time periods, and for each time period identifies multiple groups of flows with each group including one or more individual flows. For each identified group, flow exporter 670 identifies a set of attributes by aggregating one or more subsets of attributes of one or more individual flows in the group as described below in greater detail. In some embodiments, the subset of attributes of each individual flow in each group is the aggregated statistics of the individual flow.

Additionally, the event correlator 685 retrieves source event data from the FIFO storage 675 and destination event data from the queue 690, and correlates the event data to generate correlated events, and stores the correlated events in the flow records storage 678 for retrieval by the flow record publisher 680. After the multiple time periods, flow exporter 670 provides the set of attributes for each group identified in the multiple time periods to a server (e.g., an analysis appliance such as the centralized data analytics appliance 105) for further analysis of the data flows identified. In some embodiments, the FIFO storage 675 is also used as a buffer for destination events that need to be sent to source machines when the host 600 is a destination machine for a data message flow.

As shown, flow exporter 670 includes flow identifier/statistics collector 671, flow identifier and statistics storage 672, flow collector timer 673, flow collector 674, first-in first-out (FIFO) storage 675, configuration data storage 676, flow aggregator 677, flow group record storage 678, a flow publisher timer 679, and a flow group record publisher 680 for collecting and processing flow data to produce aggregated flow group records and publishing the set of flow aggregated records.

Flow exporter 670 receives flow information, including flow identifiers and statistics, at flow identifier/statistics collector 671. In some embodiments, the received flow information is derived from individual data messages that make up the flow and includes context data used in making service decisions at service engines 615. Flow exporter 670 stores the received information associated with particular flows in flow identifier and statistics storage 672. The statistics, in some embodiments, are summarized (accumulated) over the life of the particular flow (e.g., bytes exchanged, number of packets, start time, and duration of the flow).

Flow collector 674, in some embodiments, monitors the flows to determine which flows have terminated (e.g., timeouts, FIN packets, RST packets, etc.) and collects the flow identifiers and statistics and pushes the collected data to FIFO storage 675. In some embodiments, flow collector 674 collects additional configuration data from configuration data storage 676 and includes it with the data collected from flow identifier and statistics storage 672 before sending the data to FIFO storage 675.

Additionally, the flow collector 674, in some embodiments, collects data for long-lived active flows (e.g., flows lasting longer than half a publishing period) from flow identifier and statistics storage 672 before the end of a publishing period provided by flow publisher timer 679. In some embodiments, the data collected for a long-lived active flow is different from the data collected for terminated flows. For example, active flows are reported using a start time, but without a duration in some embodiments. Only flows meeting certain criteria are collected by flow collector 674 in some embodiments. For example, only information for flows using a set of particular protocols (e.g., TCP, UDP, ESP, GRE, SCTP) are collected, while others are dropped or ignored. In some embodiments, additional types of traffic, such as broadcast and multicast, safety check (e.g., having ruleID=0 or 0 rx and tx byte/packet counts), L2 flows, flows which are not classified as one of (1) inactive, (2) drop, or (3) reject, are dropped (i.e., not collected or not placed into FIFO storage 675).

In some embodiments FIFO storage 675 is a circular or ring buffer such that only a certain number of sets of flow identifiers and flow statistics can be stored before old sets are overwritten. In order to collect all the data placed into FIFO storage 675, or at least to not miss too much (e.g., miss less than 5% of the data flows), flow aggregator 677 pulls data stored in FIFO storage 675 based on a flow collection timer 673 and aggregates the pulled data into aggregated flow group records. Some embodiments pull data from FIFO storage 675 based on a configurable periodicity (e.g., every 10 seconds), while other embodiments, alternatively or in addition to the periodic collection, dynamically determine when to collect data from FIFO storage 675 based on a detected number of data flows (e.g. terminated data flows, a total number of active data flows, etc.) and the size of FIFO storage 675. Each set of flow data pulled from FIFO storage 675 for a particular flow, in some embodiments, represents a unidirectional flow from a first endpoint (e.g., machine or DCN) to a second endpoint. If the first and second endpoints execute on the same host computer, in some embodiments, a same unidirectional flow is captured at different ports 660-665 of host 600. To avoid double counting a same data message provided to flow identifier 671 from the two ports 660-665, flow identifier 671 uses a sequence number or other unique identifier to determine if the data message has been accounted for in the statistics collected for the flow. Even if duplicate data messages for a single unidirectional flow have been accounted for, the flow aggregator 677 additionally, in some embodiments, combines sets of flow data received for the separate unidirectional flows into a single set of flow data. In some embodiments, this deduplication (deduping) of flow data occurs before further aggregation and in other embodiments occurs after an aggregation operation.

Flow aggregator 677, in some embodiments, receives a set of keys from the analysis appliance through a network manager computer that specify how the flow data sets are aggregated. After aggregating the flows, in some embodiments, the flow aggregator 677 performs a deduplication process to combine aggregated flow group records for two unidirectional flows between two DCNs 605 executing on host computer 600 into a single aggregated flow group record and stores the aggregated records in flow group record storage 678. In some embodiments, the event correlator 685 correlates source and destination events from the FIFO storage 675 and the queue 690 and returns the correlated events to the FIFO storage 675 rather than storing the correlated events in the flow records storage 678. In some such embodiments, the flow aggregator 677 aggregates flow records from the FIFO storage 675, including the correlated events. From flow group record storage 678, flow group record publisher 680 publishes the aggregated and correlated flow group records to an analysis appliance according to a configurable timing provided by flow publisher timer 679. After publishing the aggregated and correlated flow group records (and, in some embodiments, receiving confirmation that the records were received), the records stored for the previous publishing time period are deleted and a new set of aggregated flow group records are generated.

In some embodiments, one of flow aggregator 677 or context engine 610 performs another correlation operation to associate the sets of correlated contextual attributes stored in contextual attribute storage 645 with the aggregated flow group records stored in flow group record storage 678. In some embodiments, the correlation includes generating new flow group records with additional attribute data included in existing attribute fields or appended in new attribute fields. In other embodiments, the sets of correlated contextual attributes and aggregated flow group records are tagged to identify related sets of aggregated flow group records and contextual attribute data. In some embodiments, the generated new flow group records are published from one of the publishers (e.g., flow group record publisher 680 or context publisher 647) while in other embodiments, flow group record publisher 680 publishes the tagged aggregated flow group records and context publisher 647 publishes the tagged sets of correlated contextual attributes.

Anomaly detection engine 622, in some embodiments, receives flow data (from any of flow identifier and statistics storage 672, FIFO storage 675, or flow group record storage 678) and context data from context engine 610 and detects, based on the received data, anomalous behavior associated with the flows. For example, based on context data identifying the application or process associated with a flow, anomaly detection engine 622 determines that the source port is not the expected source port and is flagged as anomalous. The detection in some embodiments includes stateful detection, stateless detection, or a combination of both.

Stateless detection does not rely on previously collected data at the host, while stateful detection, in some embodiments, maintains state data related to flows and uses the state data to detect anomalous behavior. For example, a value for a mean round trip time (RTT) or other attribute of a flow and a standard deviation for that attribute may be maintained by anomaly detection engine 622 and compared to values received in a current set of flow data to determine that the value deviates from the mean value by a certain number of standard deviations that indicates an anomaly. In some embodiments, anomaly detection engine 622 appends a field to the set of context data that is one of a flag bit that indicates that an anomaly was detected or an anomaly identifier field that indicates the type of anomaly detected (e.g., a change in the status of a flow from allowed to blocked [or vice versa], a sloppy or incomplete TCP header, an application/port mismatch, or an insecure version of an application). In some embodiments, the additional context data is provided to context engine 610 separately to be correlated with the other context data received at context engine 610. As will be understood from the discussion above by a person having ordinary skill in the art, the anomaly detection process, in some embodiments, uses contextual attributes not in L2-L4 headers such as data included in L7 headers and additional context values not found in headers.

In some embodiments, anomaly detection engine 622 takes an action or generates a suggestion based on detecting the anomaly. For example, anomaly detection engine 622 can block an anomalous flow pending user review or suggest that a new firewall rule be added to a firewall configuration.

Machine learning engine 624, in some embodiments, receives flow data (from any of flow identifier and statistics storage 672, FIFO storage 675, and flow group record storage 678) and context data from context engine 610 and performs analysis of the received data. The received data (e.g., flow group records), in some embodiments, includes attributes normally recorded in a five tuple as well as additional L7 attributes and other contextual attributes such as user sid, process hash, URLs, appId, etc., that allow for better recommendations to be made (e.g., finer-grained firewall rules). In some embodiments, the analysis identifies possible groupings of DCNs 605 executing on host computer 600. In some embodiments, the analysis is part of a distributed machine learning processing and the results are provided to context engine 610 as an additional contextual attribute.

The distributed analytical data collection system described in FIG. 6 uses two different approaches to collect analytical data. For one set of flows, the first approach has each host (1) collecting analytical data along with related contextual data regarding data message flows that pass through each host, and (2) reporting to the analysis appliance (e.g., centralized data analytics appliance 105) the collected analytical and contextual data without correlating the data first on the host. Under this approach, the analysis appliance performs a correlation operation to correlate data received from different hosts, processes the data to be stored in a time series data storage, and performs analysis on the stored data. For this approach, each host includes numerous modules (e.g., context engine 610, context publisher 647, context publisher timer 646, contextual attributes storage 645, flow identifier/statistics collector 671, flow identifier and statistics storage 672, flow collector timer 673, flow collector 674, FIFO storage 675, configuration data storage 676, flow aggregator 677, flow group record storage 678, flow publisher timer 679, and flow group record publisher 680) in the flow exporter 670 and context exporter 640 for use in collecting data to provide to the analysis appliance. Additional details regarding the first approach are also described in commonly owned U.S. Patent Application Publication No. 2021/0029050, entitled “HOST-BASED FLOW AGGREGATION,” filed on Jul. 23, 2019. U.S. Patent Application Publication No. 2021/0029050 is incorporated herein by reference in its entirety.

For another set of flows, the second approach has each source host (1) collecting analytical data along with related contextual data regarding data message flows starting on each host (i.e., flows from one or more source machines executing on the source host), (2) receiving analytical data (i.e., event data) from destination hosts that receive the flows from the source host, (2) correlating the source analytical data collected on the source host and destination analytical data received from the destination hosts, and (4) reporting the correlated data to the analysis appliance. For this approach, in addition to the numerous modules mentioned above in the flow exporter 670 and context exporter 640, each host also uses a queue 690 for receiving data from the destination hosts and an event correlator 685 in the flow exporter 670 for collecting and correlating the data to be provided to the analysis appliance.

In some embodiments, the first approach may be taken for a particular flow, and based on the data collected for that flow, a user (e.g., network administrator) may switch to the second approach for the particular flow. For instance, the user may determine that second approach would be more efficient for a multicast flow than the first approach as the source host computer would know how many destination events to expect to receive, leading to more accurate data with regard to potential packet drops. In another example, a user may determine that the host computers have sufficient resources to perform the correlation operation while the analysis appliance's resources would be better used for other operations, and as a result, switch a flow from the first approach to the second approach in order to free up resources on the analysis appliance.

As described above, contextual attributes associated with the first group of data message flows are collected in some embodiments at the context exporter 640, while the statistical data associated with the first group of data message flows, as well as the source and destination event data associated with the second group of data message flows, are collected at the flow exporter 670. More specifically, the flow collector 674 of the flow exporter 670, in some embodiments, collects the statistical data, and the event correlator 685 of the flow exporter 670 collects the event data. In some embodiments, the context exporter 640 and the flow collector 674 of the flow exporter 670 also collect contextual attributes and statistical data for the second group of data message flows. The collected contextual attributes and statistical data for the second group of data message flows is correlated with the event data on the host computer 600 prior to being provided to the analysis appliance in some embodiments, while in other embodiments, the collected contextual attributes and statistical data for the second group of data message flow is provided to the analysis appliance separately from the correlated event data.

In some embodiments, a user may specify for the first approach to be used for a first group of data message flows that match a first set of attributes, and specify for the second approach to be used for a second group of data message flows that match a second set of attributes. In some embodiments, the first and second sets of attributes are specified by first and second sets of keys received by hosts from the analysis appliance. Each of the first and second sets of keys, in some embodiments, defines how data associated with each of the first and second groups of data message flows is to be aggregated. For instance, in some embodiments, the first set of attributes specified by the first set of keys may include attributes such as machine identifier, protocol, source network address, destination network address, resource usage, and security identifier, while the second set of attributes specified by the second set of keys may include a set of flow types, such as broadcast data message flows and multicast data message flows. Accordingly, in some embodiments, the data message flows in the first group may have some overlap with the data message flows in the second group (e.g., a multicast data message flow associated with a particular machine identifier specified by the first set of attributes).

In some embodiments, subsequent to reviewing the collected data, the user may dynamically modify the keys. For instance, a report generated by the analysis appliance may include anomalies detected during an analysis of the data, and based on these detected anomalies, the user may determine that more data and/or other types of data should be collected to provide a better and more complete view of the detected anomalies and, in some embodiments, to identify a root cause of the anomalies.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

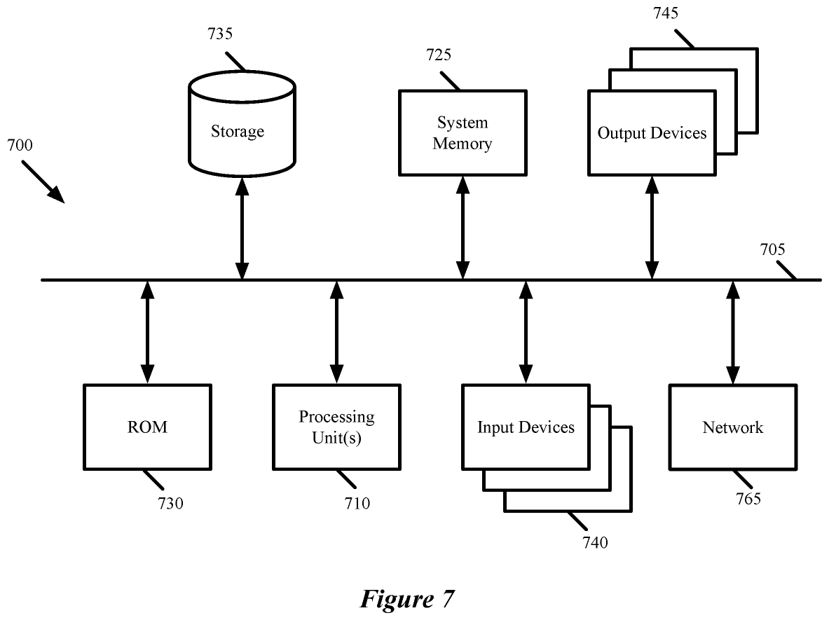

FIG. 7 conceptually illustrates a computer system 700 with which some embodiments of the invention are implemented. The computer system 700 can be used to implement any of the above-described hosts, controllers, gateway, and edge forwarding elements. As such, it can be used to execute any of the above described processes. This computer system 700 includes various types of non-transitory machine-readable media and interfaces for various other types of machine-readable media. Computer system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the computer system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) 710 may be a single processor or a multi-core processor in different embodiments. The read-only-memory (ROM) 730 stores static data and instructions that are needed by the processing unit(s) 710 and other modules of the computer system 700. The permanent storage device 735, on the other hand, is a read-and-write memory device. This device 735 is a non-volatile memory unit that stores instructions and data even when the computer system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device. Like the permanent storage device 735, the system memory 725 is a read-and-write memory device. However, unlike storage device 735, the system memory 725 is a volatile read-and-write memory, such as random access memory. The system memory 725 stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices 740 enable the user to communicate information and select commands to the computer system 700. The input devices 740 include alphanumeric keyboards and pointing devices (also called “cursor control devices”). The output devices 745 display images generated by the computer system 700. The output devices 745 include printers and display devices, such as cathode ray tubes (CRT) or liquid crystal displays (LCD). Some embodiments include devices such as touchscreens that function as both input and output devices 740 and 745.

Finally, as shown in FIG. 7, bus 705 also couples computer system 700 to a network 765 through a network adapter (not shown). In this manner, the computer 700 can be a part of a network of computers (such as a local area network (“LAN”), a wide area network (“WAN”), or an Intranet), or a network of networks (such as the Internet). Any or all components of computer system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of correlating data message flows sent between a plurality of machines executing on a plurality of host computers of a network, the method comprising:
at a first host computer executing a first machine:
sending, to a second machine executing on a second host computer, a first data message belonging to a first data message flow between the first and second machines;
receiving a destination event associated with the first data message from the second host computer;
correlating the received destination event with a source event associated with the first data message and generated by the first host computer to create a correlated event; and
sending the correlated event to a centralized data analytics appliance that analyzes and stores correlated events.

2. The method of claim 1, wherein:
sending the first data message to the second machine on the second host computer further comprises sending the first data message to the plurality of machines executing on the plurality of host computers including the second machine executing on the second host computer;
receiving a destination event associated with the first data message from the second host computer further comprises receiving a plurality of destination events associated with the first data message from the plurality of host computers including the second host computer; and
correlating the received destination event with the source event further comprises correlating the plurality of received destination events with the source event.

3. The method of claim 2, wherein the first data message is a multicast first data message.

4. The method of claim 2, wherein the first data message is a broadcast first data message.

5. The method of claim 1, wherein the destination event indicates that the first data message was allowed at the second host computer.

6. The method of claim 1, wherein the destination event indicates that the first data message was blocked at the second host computer.

7. The method of claim 1, wherein the correlated event is a first correlated event, the method further comprising:
sending, to a third machine executing on a third host computer, a second data message belonging to a second data message flow between the first machine and third machine;
detecting that the second data message was blocked by the first host computer;
generating a second correlated event indicating that the second data message flow between the first and third machines was blocked by the first host computer; and
sending the second correlated event to the centralized data analytics appliance.

8. The method of claim 1, wherein sending the first data message comprises sending the first data message on a data plane of the network and sending the correlated event comprises sending the correlated event on a management plane of the network.

9. The method of claim 1, wherein the correlated event is one of a plurality of correlated events created by the source first host computer and sent to the data analytics appliance.

10. The method of claim 9, wherein the first host computer is configured to send correlated events to the data analytics appliance at a specified frequency.

11. The method of claim 1, wherein:
the first host computer comprises (i) a queue for receiving destination events and (ii) a buffer for storing generated source events;
the first host computer is associated with a first network address and the queue of the first host computer is associated with a second network address that is different from the first network address; and
receiving the destination event comprises retrieving the destination event from the queue of the first host computer.

12. The method of claim 11, wherein the first host computer stores generated source events in the buffer for a fixed duration of time.

13. The method of claim 12, wherein after the fixed duration of time, source events for which destination events have not yet been received are dropped.

14. The method of claim 12, wherein after the fixed duration of time, source events for which destination events have not yet been received are sent to the data analytics appliance as incomplete.

15. A method of correlating data message flows sent between a plurality of machines executing on a plurality of host computers of a network, the method comprising:
at a first host computer executing a first machine:
for a first plurality of data message flows, collecting (i) contextual attributes associated with the first plurality of data message flows, and (ii) statistical data associated with the first plurality of data message flows;
providing the collected contextual attributes and statistical data to an analysis appliance that (i) correlates, (ii) aggregates, and (iii) analyzes contextual attributes and statistical data for data message flows;
for a second plurality of data message flows, (i) collecting source event data associated with the second plurality of data message flows from the first machine and (ii) receiving destination event data associated with the second plurality of flows from a second host computer that executes a second machine;
correlating the source event data and the destination event data for the second plurality of data messages; and
providing the correlated event data for the second plurality of data messages to the analysis appliance.

16. The method of claim 15, wherein:
the first plurality of data message flows comprises data message flows matching a first set of attributes and the second plurality of data message flows comprises data message flows matching a second set of attributes;
the first set of attributes is specified by a first set of keys received from the analysis appliance and the second set of attributes is specified by a second set of keys received from the analysis appliance; and
the first and second sets of keys define how data associated with each of the first and second pluralities of data message flows is to be aggregated.

17. The method of claim 16, wherein:
the first set of attributes specified by the first set of keys comprise at least two of machine identifier, protocol, source network address, destination network address, resource usage, and security identifier; and
the second set of attributes specified by the second set of keys comprise a set of flow types, the set of flow types comprising broadcast data message flows and multicast data message flows.

18. The method of claim 15, wherein:
collecting contextual attributes associated with the first plurality of data message flows comprises collecting contextual attribute associated with the first plurality of data message flows at a context exporter executing on the first host computer; and
collecting statistical data associated with the first plurality of data message flows comprises collecting statistical data associated with the first plurality of data message flows at a flow exporter executing on the first host computer.

19. The method of claim 18, wherein providing the collected contextual attributes and statistical data to the analysis appliance comprises:
providing the collected contextual attributes to the analysis appliance via the context exporter; and
providing the collected statistical data to the analysis appliance via the flow exporter.

20. The method of claim 18, wherein:
the flow exporter comprises an event correlation engine for (i) retrieving the destination event data from a queue of the first host computer to which the destination event data is sent and (ii) correlating source and destination event data;
correlating the source event data and the destination event data for the second plurality of data message flows comprises correlating the source event data and the destination event data at the event correlation engine; and
providing the correlated event data for the second plurality of data message flows to the analysis appliance comprises providing the correlated event data for the second plurality of data message flows to the analysis appliance via the flow exporter.

21. The method of claim 20, wherein:
the queue has an assigned network address that is different from an assigned network address of the first host computer; and
the destination event data is addressed to the assigned network address for the queue.

22. The method of claim 15, wherein:
collecting contextual attributes and statistical data associated with the first plurality of data message flows further comprises aggregating the collected contextual attributes and collected statistical data to generate a single set of aggregated data; and
providing the collected contextual attributes and statistical data to the analysis appliance comprises providing the generated single set of aggregated data to the analysis appliance. wherein the analysis appliance aggregates the correlated event data

23. The method of claim 15, wherein the analysis appliance (i) processes the collected contextual attributes and statistical data for the first plurality of data message flows and the correlated event data for the second plurality of data message flows, and (ii) stores the processed contextual attributes and statistical data for the first plurality of data message flows and the processed correlated event data for the second plurality of data message flows in a time series data storage.

24. The method of claim 23, wherein:
the analysis appliance performs a first analysis on the contextual attributes and statistical data for the first plurality of data message flows stored in the time series data storage and a second analysis on the correlated event data for the second plurality of data message flows stored in the time series data storage;
generates a first report based on the first analysis and a second report based on the second analysis; and
provides the first and second reports through a user interface for viewing by a network administrator for the network.

25. The method of claim 23, wherein the analysis appliance processes the collected contextual attributes and statistical data for the first plurality of data message flows by performing a correlation operation to correlate the collected contextual attributes and statistical data for the first plurality of data message flows.
